(19) United States
(12) Patent Application Publication
(10) Pub. No.: US 2014/0043277 A1
(43) Pub. Date: Feb. 13, 2014

(54) APPARATUS AND ASSOCIATED METHODS

(71) Applicants: Jari Saukko, Tampere (FI); Petteri Kauhanen, Espoo (FI); Janne Bergman, Tampere (FI)

(72) Inventors: Jari Saukko, Tampere (FI); Petteri Kauhanen, Espoo (FI); Janne Bergman, Tampere (FI)

(73) Assignee: NOKIA CORPORATION, Espoo (FI)

(21) Appl. No.: 13/570,728

(22) Filed: Aug. 9, 2012

(51) Int. Cl. G06F 3/041; G06F 3/044

(52) U.S. Cl. 345/174; 345/173

(57) ABSTRACT

An apparatus comprising at least one processor; and at least one memory including computer program code, the at least one memory and the computer program code configured to, with the at least one processor, cause the apparatus to perform at least the following: enable determination of a neutral position of a grip of a user holding a portable electronic device with respect to a user interface of the portable electronic device; and enable interpretation of a detected movement of the user grip away from the determined neutral position to control the functionality provided using the portable electronic device.

### TECHNICAL FIELD

The present disclosure relates to the field of user interfaces, associated methods, computer programs and apparatus. Certain disclosed aspects/examples relate to portable electronic devices, in particular, hand-portable electronic devices, which may be hand-held in use (although they may be placed in a cradle in use). Such hand-portable electronic devices include Personal Digital Assistants (PDAs), mobile telephones, smartphones and other smart devices, and tablet PCs.

Portable electronic devices/apparatus according to one or more disclosed aspects/examples may provide one or more: audio/text/video communication functions such as tele-communication, video-communication, and/or text transmission (Short Message Service (SMS)/Multimedia Message Service (MMS)/emailing functions); interactive/non-interactive viewing functions (such as web-browsing, navigation, TV/program viewing functions); music recording/playing functions such as MP3 or other format, FM/AM radio broadcast recording/playing; downloading/sending of data functions; image capture functions (for example, using a digital camera); and gaming functions.

### BACKGROUND

Modern portable electronic devices allow users to make user inputs in different ways. For example, a mobile telephone with a touch sensitive screen may allow a user to make gestures on that screen to perform user inputs. As another example, a digital camera may allow a user to press keys on the camera to make user inputs.

The listing or discussion of a prior-published document or any background in this specification should not necessarily be taken as an acknowledgement that the document or background is part of the state of the art or is common general knowledge. One or more aspects/examples of the present disclosure may or may not address one or more of the background issues.

### SUMMARY

In a first aspect there is provided an apparatus comprising at least one processor; and at least one memory including computer program code, the at least one memory and the computer program code configured to, with the at least one processor, cause the apparatus to perform at least the following:
enable determination of a neutral position of a grip of a user holding a portable electronic device with respect to a user interface of the portable electronic device; and
enable interpretation of a detected movement of the user grip away from the determined neutral position to control the functionality provided using the portable electronic device.

For example, a user of a mobile telephone device may hold the device with both hands to see the images/text on screen. The position of the user's hands while holding/gripping the device at rest may be determined by the apparatus to be the neutral position of the grip of the user. If the user moves one or both hands away from that neutral position, whilst still gripping the device, this is detected and interpreted by the apparatus as a user input, which is used to control the functionality of the device. This may provide an advantage to a user that they do not need to remove their grip from the device in order to make a user input.

For example, it may be that the user is using a camera application on their mobile telephone device which is equipped with a built-in camera. A movement of the user's grip while the device is operating the camera application may be interpreted by the apparatus as an intention to perform a zoom function, and the camera may zoom in/out based on the user's movement of the user's grip on the device.

Because the user in this example is not required to remove a hand from the device to interact with the device and perform a zoom (for example, by interacting with a zoom control displayed on the screen of the device), the user may be able to keep the camera of the device more stable during zooming and taking a photograph. Further, the user may find it easier to keep the camera pointing at and focussed on the object of interest whilst zooming.

Further, performing user inputs by the movement of a user's grip being detected as disclosed herein may provide the user with a more intuitive way of interacting with a portable electronic device.

Also, the user may be able to interact with the device whilst, for example, wearing gloves. This overcomes a problem with devices having touch-sensitive screens where skin contact is required on the screen for an input to be detected. For example, a user may be listening to a media player in winter, and so for example, the user is wearing gloves. The media player may have a capacitive touch sensitive screen capable of detecting the presence and movement of objects, such as the user's hand(s), within a few centimeters of the screen. The user may be able to control the media player functionality by changing his or her grip on the media player away from a neutral grip, without having to remove their gloves. It may be envisaged, as discussed in more detail below, that a variety of different user inputs may be made simply by a user changing their grip position on a device in different ways (for example, by accounting for the distance moved and/or the speed/acceleration of motion).

The apparatus may be configured to enable interpretation of a detected movement of the user grip away from the neutral position whilst the user remains holding/gripping the portable electronic device. Therefore the user may advantageously comfortably hold a device, and interact with that device, without necessarily letting go of the device.

The apparatus may be configured to enable interpretation of a detected movement of the user grip away from the neutral position whilst the user does not remain holding the portable electronic device. For example, a user may be able to hold a portable electronic device and the user's neutral grip may be determined by the apparatus. The apparatus may then be able to interpret a detected user movement wherein a hand is removed from that device as a particular user input (such as “close file”, or “end neutral grip mode” in order to stop the device interpreting detected movements of the user's grip away from the neutral position as user inputs.)

The apparatus may be configured to enable performance of a function provided using the portable electronic device corresponding to the movement of the user grip away from the determined neutral position. That is, the apparatus may be able to interpret a movement of the user grip away from the neutral position as a user input, and also carry out the function corresponding to that user input (for example, the apparatus may interpret a movement of a user's grip holding/gripping an e-book device away from the neutral position as a “turn page” command, and then display the next page of an e-book on the e-book device being held).

The user interface of the portable electronic may comprise one or more of:
a touch sensitive input panel of the portable electronic device;
a capacitive touch input panel of the portable electronic device;
an input sensor of the portable electronic device;
an input sensing array of the portable electronic device; and
an output display of the portable electronic device.

Modern touch sensitive panels, in particular capacitive touch panels, are capable of detecting objects up to several centimeters away from the panel surface, including in a direction away from perpendicular to the panel surface. That is, a user need not directly touch the capacitive touch panel since the sensing range of the panel is hemispherical and spreads beyond the edges of the panel itself. This allows such a touch panel to detect all objects in the vicinity (of a few centimeters) of the panel. Thus, in the example of a smartphone having a touch sensitive display screen substantially over one face of the device, the position of a user's fingers and thumbs holding the edges of the device, while not necessarily making contact with the touch panel at the face, may be detected by the touch panel.

Other sensing elements may also be used to determine the position of a user's fingers and thumbs holding a device. For example, one or more sensors (for example, light detecting sensors, pressure sensors, biosensors, stress/strain sensors, infra-red sensors, surface acoustic wave sensors/detectors) may be arranged around the edge of a device for detecting a user holding the device and any movement of the user's grip on that device.

In general, the methods and apparatus disclosed herein may be used with any sensing element which is able to detect the position and movement of a user's grip on a device. One scenario is that the device has a panel able to sense the position and movement of objects close to it but not necessarily in contact with it, such as a capacitive touch-sensitive panel, such as the screen of the device. In this scenario, a user can hold the edge(s) of the device, and while not directly touching the sensing panel, the sensing panel can still detect the position and movement of the user's grip. A second scenario is that the device has a touch sensor(s) on the edge(s) of the device where a user may directly touch the sensors, and the sensor(s) are able to sense the position and movement of objects actually in contact with the sensor(s).

A third scenario is that some 3-D input capable technology is used to detect the position and movement of a user's hand(s) holding a device which need not necessarily have a touch-sensitive screen (in which a user cannot interact with the screen to provide inputs, for example). Such 3-D capable technology may be, for example, a capacitive “stripe” on one or more sides/edges of the device. The capacitive “stripe”, configured for use with 3-D input enabled technology, may be able to detect a user's grip, and movement of that grip, on the device. The position and movement of the user's hand(s) may be detected in some example, depending on the sensing technology in place, by detecting the user's hand in contact with the device and/or proximal to but not in contact with the device.

The functionality provided using the portable electronic device may be associated with one or more of: a camera application, a movie application, an image viewer, a map viewer, an audio player application, a web browser, a document reader application, an e-book application, a game, a communication application, an address book application, a file manager, a menu grid, and a multi-desktop system. The skilled person will appreciate a wide range of applications, and any user interface functionality between a user and an electronic device, are suitable for use with the apparatus and methods described herein.

The control of the functionality provided using the portable electronic device may comprise one or more of: zooming in and out of a static or moving image; moving forward and backward through a series of images, pages, browser windows, audio/video files or entries; controlling a game element; and fast-forwarding and rewinding an audio or video file. Again, the skilled person will appreciate a wide range of functionality control is possible using the apparatus and methods described herein.

The detected movement of the user grip away from the determined neutral position to control the functionality provided using the portable electronic device may comprise tilting one or both hands which provide the user grip towards or away from the user interface. For example, a user holding a digital camera may move both hands outwards away from a touch sensitive screen of the camera to zoom out, and may move both hands inwards towards the touch sensitive screen to zoom in. As another example, a user may be browsing the internet using a PDA by holding the PDA in a landscape orientation with both hands. The user may be able to hold their left hand away from the screen to skip back a page, and move their left hand towards the screen to skip forward a page. Tilting the right hand away or towards the screen may provide a “refresh” command to the browser to reload the currently viewed webpage.

The detected movement of the user grip away from the determined neutral position to control the functionality provided using the portable electronic device may comprise tilting one hand which provides a user grip towards the user interface and tilting the other hand which provides a user grip away from the user interface. Such grip movements may be interpreted as a rotation of the device. The information on the angular changes made by the user's hands with respect to the user interface of the device may be interpreted in a similar way to gyroscope or accelerometer orientation information. Thus an advantage may be obtained using an apparatus as disclosed herein, as providing back-up or verification measurements of device orientation, from the user's change of grip on a device to complement gyroscope or accelerometer information from the device. Alternatively, it may be possible for a device to provide orientation information without the need for, for example, a gyroscope or accelerometer, if the movement of a user's grip on the device may be interpreted as a rotation away from a known position.

Interpretation of the detected movement of the user grip away from the determined neutral position may comprise consideration of one or more of: the direction of detected movement of the user grip away from the determined neutral position; the magnitude of detected movement of the user grip away from the determined neutral position; the speed of detected movement of the user grip away from the determined neutral position; the angular velocity of detected movement of the user grip away from the determined neutral position; the acceleration of detected movement of the user grip away from the determined neutral position; and the pressure applied by the user grip during the detected movement of the user grip away from the determined neutral position. Thus the neutral position may be determined, and movements away from the neutral position may be interpreted, if a user tilts his or her hand(s), if a user tilts a finger or fingers on one or both hands, if the user moved a thumb or both thumbs, or any movement of at least a part of a user's hand(s) gripping a portable electronic device.

Thus advantageously a wide range of user inputs may potentially be made to a device via a user simply moving one or both hands away from a neutral position without having to release a grip. Of course, the same user grip movement may be interpreted differently by different applications on the same device. For example, tilting a right hand outwards away from a screen of a device running a music player may skip to the next track, whereas performing the same movement on the same device running a movie player may fast forward through the movie. As another example, tilting a finger of a hand gripping a device upwards so that the finger loses contact with the device may be interpreted as a user input, and re-contacting the finger with the device by tilting it downwards may be interpreted as another user input. For example, if watching a movie on a device, tilting a finger up away from the device may be interpreted as a “pause” input, and tilting the finger back down to contact the device may be interpreted as a “resume” input. The angular speed and/or velocity of a tilted finger or hand may be determined and interpreted as a particular user input. A fast finger tilt may be interpreted as a fast scroll through a displayed document, whereas a slow finger tilt may be interpreted as a slow scroll, for example.

The apparatus may be configured to establish the neutral position of the grip of the user holding the portable electronic device over a predetermined period of time, during which the user grip remains substantially stationary with respect to the portable electronic device. The apparatus may be configured to re-establish the neutral position of the grip of the user holding the portable electronic device after an inactivity period. The inactivity period may be a period during which no grip is detected on the portable electronic device, or may be a period during which no movement is detected of the user's grip on the portable electronic device.

Thus the apparatus allows for calibration of the device being held so that advantageously a) different users, and the same user at different times, can use the device and the apparatus can adapt for the latest user's personal neutral grip, b) small movements and wobbles of a user's grip away from the neutral position may be ignored, allowing for smoother device operation, and c) the user is able to find a comfortable neutral grip during the calibration period to allow for a more comfortable and natural user experience.

The apparatus may be configured to determine the neutral position of the grip of the user holding the portable electronic device within a predetermined tolerance range of grip positions. The apparatus may be configured to require that a detected movement is beyond a predetermined tolerance distance away from the neutral position before interpretation of that detected movement as an input to control functionality of the portable electronic device. That is, the apparatus may be able to determine that the user is holding the device in a neutral grip within a particular angular range of grips, for example. Again, this allows grip movements away from the neutral position to be detected and interpreted as user inputs only when an “intentional” (that is, greater than the predetermined tolerance) movement is made, to allow for a smoother operation and prevent the device determining that small wobbles and minor shifts in grip position are intended as user inputs.

The portable electronic device may comprise one or more of: a mobile telephone; a smartphone, a personal digital assistant, a camera, a video camera, a navigator, a media player, a tablet computer, a remote controller, a clock, or a module for the same. The skilled person will appreciate other suitable portable electronic devices which may be used. The apparatus may be the portable electronic device or the module for the same.

The apparatus may be configured to determine the neutral position of at least a one-handed grip holding the portable electronic device. A device need not necessarily be held in two hands; for example, a user may hold a remote controller in one hand and movements on the user's finger and/or thumb position along the sides of the remote control may be interpreted as user inputs.

The apparatus may be configured to determine the neutral position of the grip of the user holding a portable electronic device in a landscape orientation.

Functionality provided using the portable electronic device may be provided on the portable electronic device. Thus, a user may hold a tablet computer displaying an image viewer, and movements made away from a neutral grip position of the tablet computer may cause the functionality of the image viewer to be accessed (for example, to zoom in/out of images and/or flick through a series of images).

Functionality provided using the portable electronic device may be provided on a second device separate to the portable electronic device but which is controlled using the portable electronic device. For example, a user may hold a remote control, or a device which can be used as a remote control, and control the functionality of a separate and distinct Blu-ray player, DVD player, or television. The portable electronic device and the second device may each be independently operable. For example, a user may be able to provide inputs to a mobile telephone which is linked to a laptop computer, thereby controlling the functionality of the laptop computer using the mobile telephone. The mobile phone and the laptop computer may each also be independently operable and each run, for example, different applications, using a different operating system, and have different screen sizes and resolutions, for example.

The apparatus may be the portable electronic device or a module for the same.

In a further aspect there is provided a computer program code configured to:
enable determination of a neutral position of a grip of a user holding a portable electronic device with respect to a user interface of the portable electronic device; and
enable interpretation of a detected movement of the user grip away from the determined neutral position to control the functionality provided using the portable electronic device.

In a further aspect there is provided a computer readable medium comprising computer program code stored thereon, the computer readable medium and computer program code being configured to, when run on at least one processor, perform at least the following:
enable determination of a neutral position of a grip of a user holding a portable electronic device with respect to a user interface of the portable electronic device; and
enable interpretation of a detected movement of the user grip away from the determined neutral position to control the functionality provided using the portable electronic device.

In a further aspect there is provided a method, the method comprising:
enabling determination of a neutral position of a grip of a user holding a portable electronic device with respect to a user interface of the portable electronic device; and
enabling interpretation of a detected movement of the user grip away from the determined neutral position to control the functionality provided using the portable electronic device.

In a further aspect there is provided an apparatus, the apparatus comprising:
means for enabling determination of a neutral position of a grip of a user holding a portable electronic device with respect to a user interface of the portable electronic device; and
means for enabling interpretation of a detected movement of the user grip away from the determined neutral position to control the functionality provided using the portable electronic device.

The present disclosure includes one or more corresponding aspects, examples or features in isolation or in various combinations whether or not specifically stated (including claimed) in that combination or in isolation. Corresponding means and corresponding functional units (e.g., position determiner, grip detector, grip movement detector, user interface, portable electronic device, and grip position calibrator) for performing one or more of the discussed functions are also within the present disclosure.

Corresponding computer programs for implementing one or more of the methods disclosed are also within the present disclosure and encompassed by one or more of the described examples.

The above summary is intended to be merely exemplary and non-limiting.

### BRIEF DESCRIPTION OF THE FIGURES

A description is now given, by way of example only, with reference to the accompanying drawings, in which:

FIG. 1 illustrates an example apparatus according to the present disclosure;

FIG. 2 illustrates another example apparatus according to the present disclosure;

FIG. 3 illustrates another example apparatus according to the present disclosure;

FIGS. 4a-4c illustrate an example apparatus and a user moving a two handed grip towards and away from the user interface of a portable electronic device according to the present disclosure;

FIGS. 5a-5c illustrate an example apparatus and a user separately moving each hand of a two handed grip away from the user interface of a portable electronic device according to the present disclosure;

FIGS. 6a-6c illustrate an example apparatus and a user separately moving each hand of a two handed grip at different speeds away from the user interface of a portable electronic device according to the present disclosure;

FIGS. 7a-7b illustrate an example apparatus and a user moving each hand of a two handed grip oppositely so as to rotate a portable electronic device according to the present disclosure;

FIGS. 8a-8b illustrate an example apparatus and a calibration procedure to determine a neutral grip position according to the present disclosure;

FIG. 9 illustrates an example apparatus where a user is able to control the functionality of a video player by changing his grip on a remote control device according to the present disclosure;

FIGS. 10a-10b illustrate an example apparatus/device in a portrait orientation, and a user holding the device with one hand;

FIG. 11 illustrates a method according to the present disclosure;

FIGS. 12a-12b illustrates illustrate the apparatus in communication with a remote server or cloud; and

FIG. 13 illustrates a computer readable medium comprising computer program code according to the present disclosure.

### DESCRIPTION OF EXAMPLE ASPECTS

Modern portable electronic devices allow users to make user inputs in different ways. For example, a mobile telephone with a touch sensitive screen may allow a user to make gestures on that screen to perform user inputs. As another example, a digital camera may allow a user to press keys on the camera to make user inputs.

Generally, performing an interaction with a touch-sensitive user interface of a device in order to make a user input requires the user to move their hand/finger/stylus over to the surface of the touch-sensitive region and make an input. For some applications, this can provide problems for the user. For example, if using a camera or mobile phone equipped with a camera to take a photo or record a movie, if the user is required to release a hand from holding the device to make a gesture on a screen of the device, then several problems may arise:
a) the camera is likely to be less stable as a handhold has been removed,
b) the user may unintentionally move the camera away from the object of interest as the user is required to concentrate on touching a zoom control rather than looking at the object of interest through the camera viewfinder,
c) it may not be easy for the user to hold the camera steady with one hand while making gestures on the screen with the other hand (particularly if a stylus is required), and
d) often touch sensitive screens require skin-contact to detect an input, so the user cannot wear any skin coverings such as gloves, or a plaster or bandage.

This disclosure describes a method of performing user inputs to interact with the functionality of a device without requiring the user to release a handhold from the device, in certain cases, without the user necessarily being required to trace gestures on a touch-sensitive screen and, in certain cases, allowing the user to wear gloves or similar while making the input, thereby overcoming the abovementioned problems.

A person may be considered, when holding a portable electronic device, to have a natural (neutral) grip position where they are comfortable holding the device. This disclosure allows a user to move their hand or hands away from a determined neutral grip position and such movements may be detected and interpreted as user inputs to a device. Thus as the user tilts their hand(s) away from the neutral position, these movements/gestures are mapped to user interface actions such as zooming in/out, selecting elements, moving forwards/backwards through elements in a series, re-orienting the device, fast-forwarding and rewinding through audio/video media, rotate image left/right, go to next/previous, and other actions. Tilting one hand may be interpreted differently to tiling both hands, which in turn may be tilted the same, or different, ways, possibly by different amounts and at different speeds.

A capacitive touch sensitive panel may be used to detect the neutral position of a user's grip and detect any movement away form that neutral position. It is possible for capacitive touch sensitive panels/screens to detect objects in the near vicinity, of a few centimeters, including in a direction away from perpendicular to the panel surface. The user need not touch the panel itself, but may hold, for example, the edges of a device comprising such a panel, and the panel may still detect the user's grip positions and any movements.

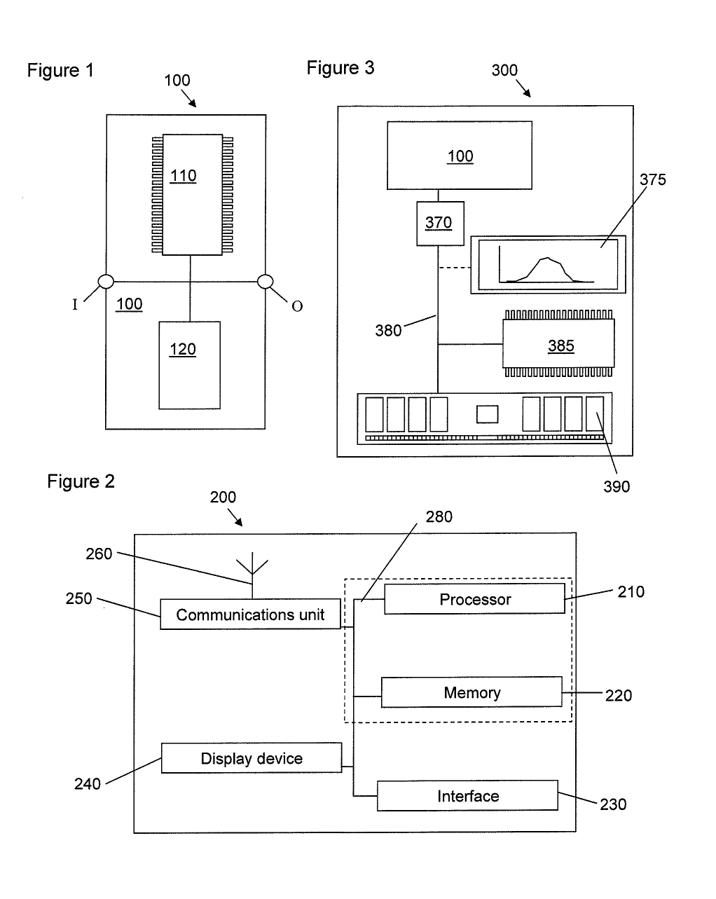

FIG. 1 shows an apparatus 100 comprising a processor 110, memory 120, input I and output O. In this example only one processor and one memory are shown but it will be appreciated that other examples may utilise more than one processor and/or more than one memory (e.g., same or different processor/memory types). The apparatus 100 may be an application specific integrated circuit (ASIC) for a portable electronic device. The apparatus 100 may also be a module for a device, or may be the device itself, wherein the processor 110 is a general purpose CPU and the memory 120 is general purpose memory.

The input I allows for receipt of signalling (e.g., by Bluetooth or over a WLAN) to the apparatus 100 from further components. The output O allows for onward provision of signalling from the apparatus 100 to further components. In this example the input I and output O are part of a connection bus that allows for connection of the apparatus 100 to further components. The processor 110 is a general purpose processor dedicated to executing/processing information received via the input I in accordance with instructions stored in the form of computer program code on the memory 120. The output signalling generated by such operations from the processor 110 is provided onwards to further components via the output O.

The memory 120 (not necessarily a single memory unit) is a computer readable medium (such as solid state memory, a hard drive, ROM, RAM, Flash or other memory) that stores computer program code. This computer program code stores instructions that are executable by the processor 110, when the program code is run on the processor 110. The internal connections between the memory 120 and the processor 110 can be understood to provide active coupling between the processor 110 and the memory 120 to allow the processor 110 to access the computer program code stored on the memory 120.

In this example the input I, output O, processor 110 and memory 120 are electrically connected internally to allow for communication between the respective components I, O, 110, 120, which in this example are located proximate to one another as an ASIC. In this way the components I, O, 110, 120 may be integrated in a single chip/circuit for installation in an electronic device. In other examples one or more or all of the components may be located separately (for example, throughout a portable electronic device such as devices 200, 300, or through a “cloud”, and/or may provide/support other functionality.

One or more examples of the apparatus 100 can be used as a component for another apparatus as in FIG. 2, which shows a variation of apparatus 100 incorporating the functionality of apparatus 100 over separate components. In other examples the device 200 may comprise apparatus 100 as a module (shown by the optional dashed line box) for a mobile phone, PDA or audio/video player or the like. Such a module, apparatus or device may just comprise a suitably configured memory and processor.

The example apparatus/device 200 comprises a display 240 such as a Liquid Crystal Display (LCD), e-Ink, or (capacitive) touch-screen user interface. The device 200 is configured such that it may receive, include, and/or otherwise access data. For example, device 200 comprises a communications unit 250 (such as a receiver, transmitter, and/or transceiver), in communication with an antenna 260 for connection to a wireless network and/or a port (not shown). Device 200 comprises a memory 220 for storing data, which may be received via antenna 260 or user interface 230. The processor 210 may receive data from the user interface 230, from the memory 220, or from the communication unit 250. The user interface 230 may comprise one or more input units, such as, for example, a physical and/or virtual button, a touch-sensitive panel, a capacitive touch-sensitive panel, and/or one or more sensors such as infra-red sensors or surface acoustic wave sensors. Data may be output to a user of device 200 via the display device 240, and/or any other output devices provided with apparatus. The processor 210 may also store the data for later user in the memory 220. The device contains components connected via communications bus 280.

The communications unit 250 can be, for example, a receiver, transmitter, and/or transceiver, that is in communication with an antenna 260 for connecting to a wireless network (for example, to transmit a determined geographical location) and/or a port (not shown) for accepting a physical connection to a network, such that data may be received (e.g., from a white space access server) via one or more types of network. The communications (or data) bus 280 may provide active coupling between the processor 210 and the memory (or storage medium) 220 to allow the processor 210 to access the computer program code stored on the memory 220.

The memory 220 comprises computer program code in the same way as the memory 120 of apparatus 100, but may also comprise other data. The processor 210 may receive data from the user interface 230, from the memory 220, or from the communication unit 250. Regardless of the origin of the data, these data may be outputted to a user of device 200 via the display device 240, and/or any other output devices provided with apparatus. The processor 210 may also store the data for later user in the memory 220.

Device/apparatus 300 may be an electronic device, a portable electronic device a portable telecommunications device, or a module for such a device (such as a mobile telephone, smartphone, PDA or tablet computer). The apparatus 100 can be provided as a module for device 300, or even as a processor/memory for the device 300 or a processor/memory for a module for such a device 300. The device 300 comprises a processor 385 and a storage medium 390, which are electrically connected by a data bus 380. This data bus 380 can provide an active coupling between the processor 385 and the storage medium 390 to allow the processor 385 to access the computer program code.

The apparatus 100 in FIG. 3 is electrically connected to an input/output interface 370 that receives the output from the apparatus 100 and transmits this to the device 300 via data bus 380. Interface 370 can be connected via the data bus 380 to a display 375 (touch-sensitive or otherwise) that provides information from the apparatus 100 to a user. Display 375 can be part of the device 300 or can be separate. The device 300 also comprises a processor 385 that is configured for general control of the apparatus 100 as well as the device 300 by providing signalling to, and receiving signalling from, other device components to manage their operation.

The storage medium 390 is configured to store computer code configured to perform, control or enable the operation of the apparatus 100. The storage medium 390 may be configured to store settings for the other device components. The processor 385 may access the storage medium 390 to retrieve the component settings in order to manage the operation of the other device components. The storage medium 390 may be a temporary storage medium such as a volatile random access memory. The storage medium 390 may also be a permanent storage medium such as a hard disk drive, a flash memory, or a non-volatile random access memory. The storage medium 390 could be composed of different combinations of the same or different memory types.

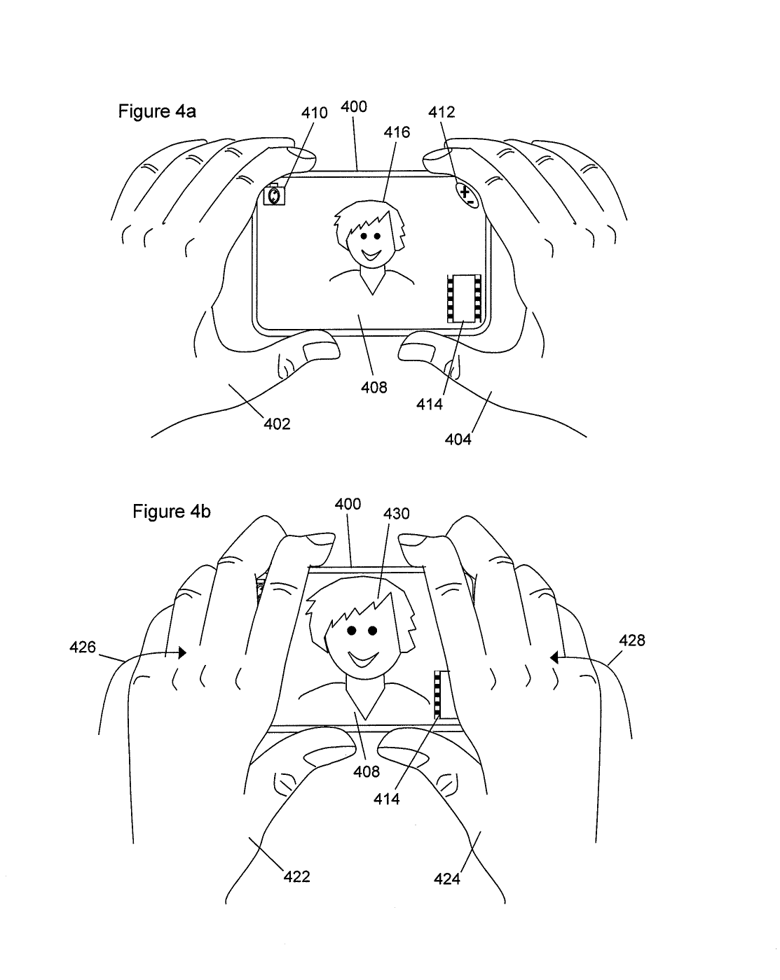

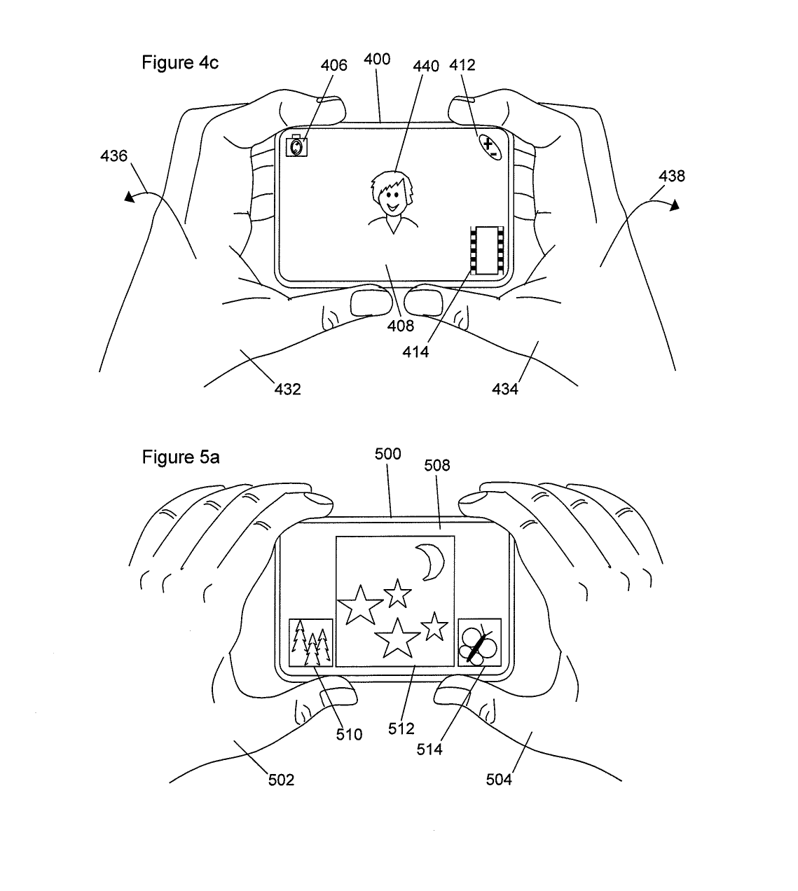

FIGS. 4a-4c illustrate an example of the apparatus/device in use. The device 400 in this example is a mobile terminal such as a mobile telephone, smartphone, or digital camera, and comprises the apparatus. It will be appreciated that the apparatus could also be considered to be the portable electronic device 400. The device 400 is equipped with an in-built camera (not shown) configured to take photographs and/or record movies. The device 400 in this example has a capacitive touch sensitive input panel/user interface 408, which overlays the display screen, so that the screen can be used as an input and output element.

The device 400 is operating in a “photograph” mode, indicated by an icon 410, so that a user can take photographs with the device 400. The user in this example is pointing the device's camera at her friend to take a photo of him, and his image 416 is displayed on the display screen so that the user can see what she is about to take a photograph of. The user is able to perform some inputs by making an appropriate touch input on particular regions of the capacitive touch sensitive input panel 408. The user is able to touch the displayed zoom control 412 to control the zoom of the camera. The user may select the “filmstrip” icon 414 to switch between a photo capture mode (used for recording a photograph) and a gallery mode (used for viewing photographs). Of course additional and/or different controls may be displayed on the screen for a user to interact with.

The capacitive touch sensitive input panel 408 is able to sense the presence and position of a user's hands/fingers/thumb at the edges of the device 400, as the panel 408 has a sensing range of several centimeters including in a direction away from perpendicular from the panel's surface. The skilled person will know of suitable capacitive panels and other touch/proximity sensitive elements which may be used within the scope of this disclosure. The user need not touch the capacitive touch-sensitive input panel 408 directly for the panel 408 to detect the position, and movement, of a proximal hand/finger.

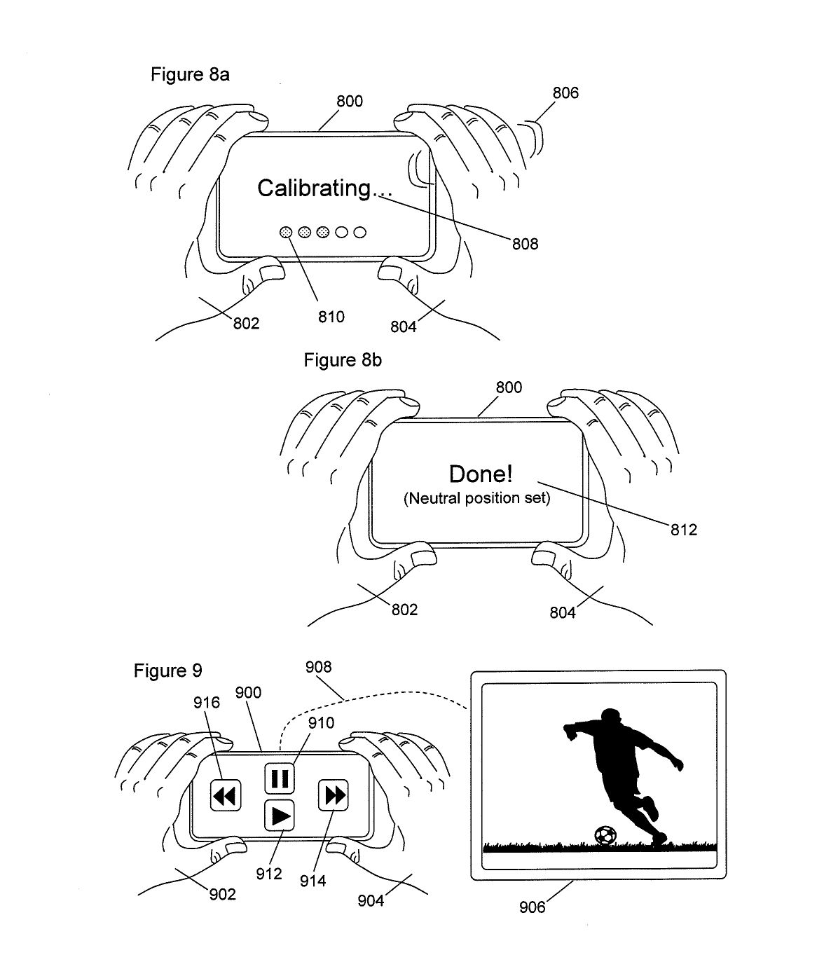

The panel 408 is able to sense the position of the user's left hand 402 and right hand 404 holding the device 400. The user is holding the device in a “neutral position”; that is, the user is holding the device is a natural way to view the screen. The apparatus is configured to enable determination of a neutral position of a grip of a user 402, 404 holding a portable electronic device 400 with respect to a user interface 408 of the portable electronic device 400. That is, the capacitive touch-sensitive panel 408 is able to determine the position of the user's hands 402, 404 as being in a neutral position as shown in FIG. 4a. Determination of the neutral position is discussed in more detail in relation to FIGS. 8a-8b.

The user wishes to zoom in to take a photograph of her friend in a close-up photograph. FIG. 4b shows that the user has moved 426 her left hand 422 and moved 428 her right hand 424 each into a different position from those of the neutral position shown in FIG. 4a. The user has moved 426, 428 her hands 422, 424 so as to twist/tilt both of them in towards the screen/panel 408. This movement 426, 428 of the user's hands 422, 424 away from the neutral position of FIG. 4a is recognised by the apparatus, via the sensing panel 408, as a user input which has the effect, in this example, of causing the camera to zoom in. The image of the user's friend 430 appears larger than the image 416 before the user made a “zoom in” movement with her hands 422, 424.

In other words, the apparatus has enabled interpretation of a detected movement of the user grip 422, 424 away from the determined neutral position to control the functionality provided using the portable electronic device 400, and cause the camera of the device 400 to zoom in. The apparatus has enabled the performance of a function, zooming in, provided using the portable electronic device 400 corresponding to the movement of the user grip 422, 424 away from the determined neutral position.

The detected movement of the user's grip 422, 424 away from the determined neutral position to control the functionality provided using the portable electronic device 400 in this example comprises tilting both hands 422, 424 which provide the user grip towards the user interface 408.

The user then changes her mind and wishes to include more of the background in the photograph of her friend. FIG. 4c shows that the user has moved 436 her left hand 432 and moved 438 her right hand 434 each into a different position from those of the neutral position shown in FIG. 4a. The user has moved 436, 428 her hands 432, 434 so as to twist/tilt both of them away from the screen/panel 408. This movement 436, 428 of the user's hands 432, 434 away from the neutral position of FIG. 4a has been recognised by the apparatus, via the sensing panel 408, as a user input. This user input has the effect, in this example, of causing the camera to zoom out. The image of the user's friend 440 appears smaller than the image 416 before the user made a “zoom out” movement with her hands 432, 434.

In other words, the apparatus has enabled interpretation of a detected movement of the user grip 432, 434 away from the determined neutral position to control the functionality provided using the portable electronic device 400, and cause the camera of the device 400 to zoom out. The apparatus has enabled the performance of a function, zooming out, provided using the portable electronic device 400 corresponding to the movement of the user grip 432, 434 432, 434 away from the determined neutral position.

The detected movement of the user grip 432, 434 away from the determined neutral position to control the functionality provided using the portable electronic device 400 in this example comprises tilting both hands 432, 434 which provide the user grip away from the user interface 408.

In other examples, it may be that the neutral position of a grip of a user holding a portable electronic device is the last grip which has been held (within a tolerance range of movement) for a predetermined period of time. For example, a user may initially pick up a device with their hands in the position shown in FIG. 4a. The user then moves the position of her hands to grip the device 400 with both hands 422, 424 tilting inwards toward the user interface 408, as shown in FIG. 4b. This “tilted-in” position may be re-determined as the new neutral position. Then, detected movement of the user's grip away from the new “tilted-in” neutral position, for example to be a more “tilted-out” position, wherein the user's hands are moved away from the user interface 408 of the device 400, may be interpreted as a movement for controlling the functionality provided using the device 400.

Thus, in some examples, it may be that an apparatus/device is configured to continually re-establish the neutral position of a grip of a user holding a portable electronic device with respect to a user interface of the portable electronic device. The re-establishment of the neutral position may be performed after a user grip has been held substantially stationary for a predetermined period of time (for example, a stationary grip/hold of 3 seconds, but the period may be longer or shorter). Essentially, the neutral position of the grip of a user may be re-determined/re-established during use of the device.

In the above examples, the user may be able to take/record the photograph by providing any suitable input, such as, for example, pressing a button or other input location (perhaps located under the user's left or right index finger on the frame of the device).

In some examples, the user input action of zooming in/out may continue while the user's hands are away from the neutral position (within the zoom limits of the camera) and may stop when the user's hands return to the neutral position. This may be likened to using a sprung self-centring jog dial for zooming, except in this example, the user need not move her fingers away from gripping the device to use such a dial to zoom in/out.

In other examples the user input action of zooming in/out may continue only while the user's hands are moving, and when the user's hands stop, away from the neutral position, the zoom factor is held until the user moves her hands again to adjust the zoom, or takes a photograph. In this way, the angular difference between the neutral position and the user's hand position may be proportional to the zoom factor wherein, for example, a greater angular movement of the user's hands away from the neutral position causes a greater zoom factor to be applied. This may be likened to using a non-sprung dial for zooming, where the dial maintains its last position upon release and does not spring back to a central position (except again, in the example of FIGS. 4a-4c, the user need not move her fingers away from gripping the device to use such a dial in order to zoom in/out).

The apparatus is thus configured to interpret detected movement of the user grip 422, 424; 432, 434 away from the determined neutral position by considering the magnitude and direction of detected movement of the user grip away from the determined neutral position.

It will be appreciated that this example considers a camera application, but that the example described may apply to the use of a movie application, an image viewer, a map viewer, a web browser, a document reader application, an e-book application, or any other application in which a user may change the zoom of the displayed content, whether static content in the case of an e-book or photo gallery application, or moving content such as the camera application above (where the displayed image moves depending on where the camera is pointing) or a movie application, where the recorded image is also moving.

This example demonstrates that the user advantageously need not take her hands off the device 400 in order to zoom in/out while taking a photograph, which may allow the user to take a better photograph.

It may be imagined that if the user was required to remove a hand from holding the device 400, for example to interact with a zoom control displayed on the touch screen 408, it may be more difficult to keep the camera pointing at her friend. In the case where a user is taking a photograph of a moving object, such as a bird in flight, it may be more difficult to keep the camera focussed on the moving object while interacting with an on-screen control to adjust the zoom, and the user may miss the opportunity to take the photograph. Thus the feature of interpreting a detected movement of a user's grip away from a neutral position (that is, the user remains holding the device during the movement) to control the functionality of the device may allow for photographs and movies to be taken more easily, and for zoom functions on certain devices to be used in an easier way.

A further advantage of using the above method for controlling a zoom function on a device with a touch sensitive screen is that the user can perform inputs while wearing gloves. Touch sensitive screens often require skin-on-screen contact for an input to be detected. In the above example the capacitive panel 408 detects the position and movement of the user's hands regardless of if the user is wearing gloves or not (or any other skin covering such as a plaster).

Further still, a user may advantageously find the above method of performing a zoom function easier and more intuitive than previous methods. The user is free to concentrate on the image being displayed, and on framing the intended image as desired, and the user need not also consider locating and using a zoom control/button (whether displayed on screen as per zoom control 412 or as an external physical button/dial). The user may simply tilt her hands towards or away from the screen in order to zoom in/out from the subject.

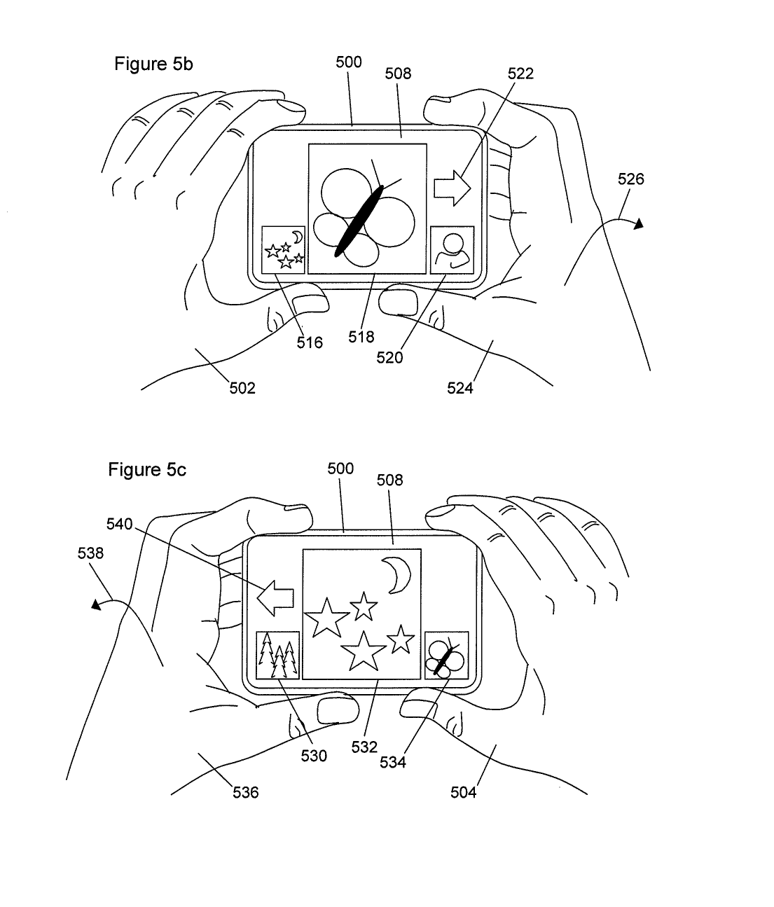

FIGS. 5a-5c illustrate an example of the apparatus/device in use. The device 500 in this example is a portable electronic device capable of displaying images such as, for example, a mobile telephone, smartphone, digital camera, PDA, (miniature) tablet computer, e-book or monitor, and comprises the apparatus. Again, as with FIGS. 4a-4c, the apparatus could be considered to be the portable electronic device 500.

The device 500 is shown running a gallery application, where a user may flip through a series of images/pages. The images in this example are photographs in a camera album, but it will be understood that this example also applies to any application where are series/list of elements is present. For example, the example applies to changing pages in a PDF, e-book or other document reader, moving back and forth through web browser pages, or entries in a catalogue application such as an address book, telephone directory, file directory/management application, or to a multi-desktop/homescreen system (to move between desktops).

The device 500 has an array of touch sensors located around the outside frame of the device 500 of any type known to those skilled in the art, such as, for example, a series of closely spaced discrete pressure sensors, infra-red sensors, surface acoustic wave sensors, or a “skin” or layer covering the frame of the device which is sensitive to touch. It will be appreciated that in other examples, a capacitive touch sensitive input panel may be used as per the example of FIGS. 4a-4c. The key point is that the device 500 is able to detect the position and movement of a user's hands holding the device 500.

The device 500 has a display screen/user interface 508, in this example displaying three images 510, 512, 514. The central image 512 is displayed as a main image and the side images 510, 514 are displayed as thumbnail images. These thumbnail images give the user an idea of the previous and next images 510, 514 in the series which may be viewed. The user is holding the device 500 with their left hand 502 and right hand 504. In FIG. 5a, the user's hands 502, 504 are in the neutral position. For example, the user may have just picked up the device 500 to view some photographs. The touch sensors around the frame of the device 500 are able to sense the position of the user's left hand 502 and right hand 504 holding the device 500. The apparatus is configured to enable determination of a neutral position of a grip of a user 502, 504 holding the portable electronic device 500 with respect to a user interface (touch sensor array) of the portable electronic device 500.

In FIG. 5a the user is viewing the central image 512 of the night sky, and wishes to view the next image 514 in the series, a butterfly, as a larger central image rather than as a thumbnail.

FIG. 5b shows that the user has moved 526 his right hand 524 into a different position from that of his right hand 504 in the neutral position by tilting 526 his right hand 524 away from the screen 508 of the device 500. This movement 526 of the user's hand 524 away from the neutral position has been recognised by the apparatus, via the sensing array at the frame of the device 500. The movement 526 has the effect, in this example, of causing the gallery application to “move images along by one to the left” as indicated by an arrow 522. Thus the device 500 shows the image of a butterfly 518, previously a thumbnail image on the right, as the central main image. The previously central image of the night sky 516 has shifted one place to the left and now appears as a thumbnail. The previous left thumbnail image of a forest 510 is no longer visible. A newly-viewable thumbnail image of a person 520 is shown on the right.

FIG. 5c shows that the user wishes to re-view the night sky as the central image, and has moved his right hand 504 back to the neutral position, and moved 538 his left hand 536 away from the neutral position and away from the device screen 508. This movement 538 of the user's left hand 536 away from the neutral position of FIGS. 5a and 5b has been recognised by the apparatus, via the sensing array at the frame of the device 500, as a user input which has the effect, in this example, of causing the gallery application to “move images along by one to the right” as indicated by the arrow 540. Thus the device 500 shows the image of a butterfly 518 again as a thumbnail image on the right, The image of the night sky 516 has shifted back one place to the right to be displayed centrally. The previous left thumbnail image of a forest 510 is again visible on the left, and the image of a person 520 is no longer shown.

In other words, shown in FIGS. 5b and 5c, the apparatus has enabled interpretation of a detected movement of the user grip 524, 536 away from the determined neutral position to control the functionality provided using the portable electronic device 500, and cause the gallery application of the device 500 to flip forward and backward through the gallery images.

The apparatus has enabled the performance of a function, flipping back and forth through a series of images, provided using the portable electronic device 500 corresponding to the movement of the user grip 524, 536 away from the determined neutral position.

The detected movement of the user grip 524 away from the determined neutral position to control the functionality provided using the portable electronic device 500 in this example comprises tilting 526 a right hand 524 away from the screen of the device while the left hand 502 remains in the neutral position, and separately, tilting a left hand 536 away from the screen of the device while the right hand 504 is in the neutral position.

In some examples, it may be that as the user's hand remains away from the neutral position, the gallery application continues to flip through the images until the end of the album is reached. In other examples, or in addition to the above, it may be that the user moves their hand away from the neutral position and back to the neutral position to move forward/backward by one image at a time.

This example demonstrates that the user advantageously need not take his hands off the device 500 in order to move through the images, which may provide a more intuitive and easy way to make user inputs. Further, different ways of moving a hand or both hands away from the neutral position may be mapped onto different user interface gesture as will be appreciated from the other examples in this disclosure.

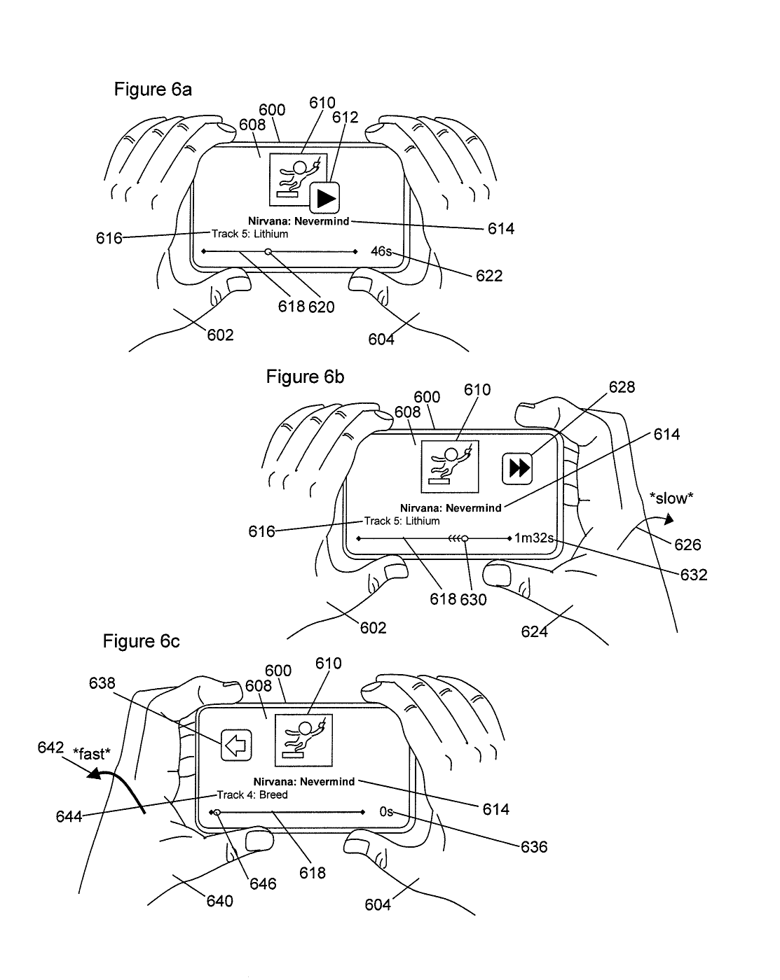

FIGS. 6a-6c illustrate an example of the apparatus in use. The device 600 in this example is a portable media player capable at least of playing audio files. The device 600 may also, for example, display images and movies, and allow connection to the internet. The device 600 may be any portable electronic device with media player functionality, such as a mobile telephone, smartphone, PDA, tablet computer, and the like.

The device 600 is shown playing a music track from an album, and the user may perform actions such as moving forward and backward through the tracks on an album, change the album being listened to, fast forward and rewind through a track, jump to a particular point in a track, pause, play, and other actions. It will be understood that this example may also apply to movie players, for example.

The device 600 has a capacitive touch sensitive display screen 608 as discussed earlier, which can detect the position and movement of a users hands at the periphery of the device, for example when the user is holding the device 600.

In FIG. 6a, the device 600 is being held by the user's left hand 602 and right hand 604 in the neutral position. For example, the user may have had the device 600 in their pocket, and have just picked up the device 600 to see what song is playing. The display screen 608 of the device 600 shows the album cover 610, the album name and artist 614, and the current track being played 616 (currently track 5). Also shown is an indicator 618 of the time elapsed of the currently playing track 616 shown as a slider position 620 on the indicator 618. The time elapsed is also shown in this example in seconds 622. The device screen in this example is also displaying a “play” icon 612 to show that the track is currently being played. It will be understood by the skilled person that the device may display additional and/or different elements. The apparatus is configured to enable determination of a neutral position of a grip of a user 602, 604 holding the portable electronic device 600 with respect to a user interface (capacitive touch sensitive display screen 608) of the portable electronic device 600.

The user decides that, after looking at the details of the currently playing track, she wishes to skip forward in the track to listen to the end of the same song 616. FIG. 6b shows that the user has slowly moved 626 her right hand 624 into a different position from that of her right hand 604 in the neutral position. This relatively slow movement 626 of the user's hand 624 away from the neutral position has been recognised by the apparatus, via the sensing screen 608 of the device 600. The slow movement 626 has the effect, in this example, of causing the music player to fast forward through the track, which is indicated by a) a fast forward icon 628 being displayed, b) the slider position 630 on the indicator 618 quickly sliding forwards, and the time elapsed 632 corresponding to the current position in the song.

FIG. 6c shows that the user has moved her right hand back to the neutral position after finding the point in track 5 616 from where she wished to listen. She now decides to skip back a track and listen to track 4 644.

The user has quickly moved 642 her left hand 640 away from the neutral position and away from the device screen 608. This relatively quick movement 642 of the user's left hand 640 away from the neutral position of FIGS. 6a and 6b has been recognised by the apparatus, via the capacitive sensing screen 608 of the device 600 as a user input which has the effect, in this example, of causing the audio player to skip back by one track, in this example from track 5 616 to track 4 644. Thus the device 600 shows track 4 644 is being played 616, from the start of the track (the slider position 646 on the indicator 618 is at the beginning and the seconds counter 636 shows “0 s” elapsed).

In other words, shown in FIGS. 6b and 6c, the apparatus has enabled interpretation of a detected movement of the user grip 624, 640 away from the determined neutral position to control the functionality provided using the portable electronic device 600, and cause the media player application of the device 600 to fast forward through a track, and skip back to a previous track. It will be appreciated that the user may, for example, move her left hand slowly away from the screen 608 to rewind a track, and may quickly move her right hand away from the screen 608 to skip forwards a track. The apparatus thus enables the performance of a function, such as fast forward/rewind and skip forwards/backwards, provided using the portable electronic device 600 corresponding to the movement of the user grip 624, 640 away from the determined neutral position.

The detected movement of the user grip 624, 640 away from the determined neutral position to control the functionality provided using the portable electronic device 600 in this example comprises tilting 626 a right hand 624 slowly away from the screen of the device 600 while the left hand 602 remains in the neutral position, and separately, quickly tilting a left hand 640 away from the screen 608 of the device 600 while the right hand 604 is in the neutral position.

It will be appreciated that other user inputs may also be made by a user moving one or both hands holding a device away from a neutral position the user's grip on the device. For example, moving both hands towards the screen quickly may pause and un-pause/play the audio, whereas moving both hands towards the screen slowly may stop audio output and/or exit the audio player application.

The apparatus is configured to interpret detected movement of the user grip 624, 640 away from the determined neutral position by considering the direction and speed of detected movement of the user grip away from the determined neutral position. In other examples, the apparatus may be able to interpret an detected change in the angular velocity of the user grip away from the determined neutral position as an input, for example if a user tilts her/her finger quickly/slowly to reward/fast forward more quickly/slowly through the current audio track, for example. In other examples, the apparatus may be able to interpret an accelerating detected movement of the user grip away from the determined neutral position as an input to reward/fast forward more quickly through the current audio track, for example. As another example, the apparatus may be able to interpret a change in pressure applied by the user grip during the detected movement of the user grip away from the determined neutral position as an input, for example to skip to the next/last album available, for example.

This example demonstrates that the user advantageously need not take her hands off the device 600 in order to move through the images, which may provide a more intuitive and easy way to make user inputs. Further, different ways of moving a hand or both hands away from the neutral position may be mapped onto different user interface gesture as will be appreciated from the other examples in this disclosure. In other examples, the apparatus could be considered to be the portable electronic device 700.

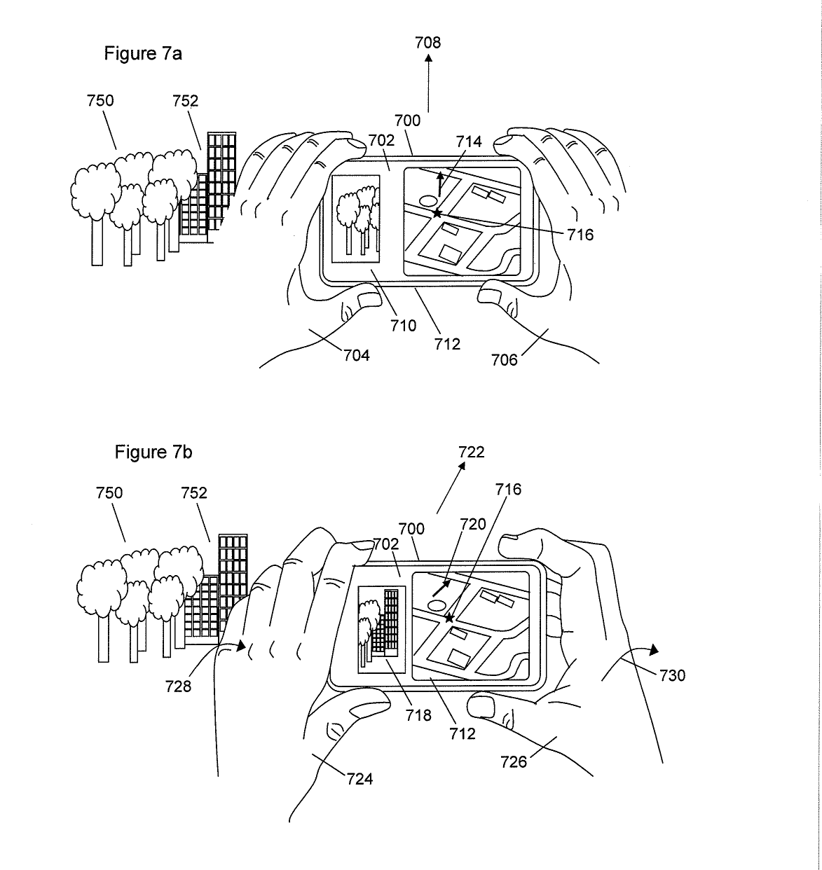

FIGS. 7a and 7b demonstrate that detection of a user grip away from a determined neutral position may be used by a device to determine its orientation. The device 700 is a portable electronic device with navigation functionality, such as a navigator, smartphone, (miniature) tablet computer, PDA, or other device. The device 700 comprises an apparatus, the apparatus itself comprising a processor and memory including computer program code.

FIG. 7a shows a user holding a navigator 700 which comprises a capacitive touch sensitive screen 702, which is able to determine the position and movement of the user's hands holding the device away from a neutral position. The navigator 700 also comprises an in-built camera (not shown). The navigator 700 displays a viewfinder 710 which is showing, in real-time, what the camera is pointing at. In this example, the camera is pointing in a direction 708 towards the trees 750 to the left of the landscape 750, 752.

The navigator 700 also has location determination functionality, such as that provided by a global positioning system (GPS). The screen 702 displays a map 712 showing the current position 716 of the user (as determined by the GPS system of the device 700), and the map 712 displays the direction 714 in which the camera of the device 700 is facing. The initial orientation 708 of the user may be determined using, for example, a compass feature or through previous GPS location measurements determining a change in location (and thus orientation).

In FIG. 7b, the user has changed where the camera of the device is pointing 722, to look at the right of the landscape 750, 752 where some tower block buildings 752 can be seen. The viewfinder 718 shows the right of the landscape 750, 752 including the tower blocks 752 so the user can easily see what the camera is now pointing at.

The user changed the direction in which the camera (and therefore the device) is pointing by moving both hands away from the determined neutral position. The user moved 728 his left hand 724 towards the screen 702 of the device 700, and moved 730 his right hand 726 away from the screen 702 of the device 700. This opposite motion of each hand has the effect of rotating the device clockwise to point further to the right as indicated by the arrow 722 compared with the direction 708 before the user moved 728, 730 his hands.

The apparatus has interpreted the movement 728, 730 of the user's grip 724, 726 away from the neutral position as a change of orientation of the device, resulting in the map 712 information being updated to show the new orientation 720 of the user with respect to the map. The position of the user 716 on the map has not changed.

Thus, the apparatus enables determination of a neutral position of a grip of a user holding a portable electronic device 700 with respect to a user interface 702 of the portable electronic device 700; and enables interpretation of a detected movement 728, 730 of the user grip 724, 276 away from the determined neutral position to control the functionality provided using the portable electronic device 700. In this case the functionality controlled includes determination of an orientation of the device 700.

The detected movement of the user grip 724, 726 away from the determined neutral position to control the functionality provided using the portable electronic device 700 in this example comprises tilting 728 one hand 724 which provides a user grip towards the user interface 702 and tilting 730 the other hand 726 which provides a user grip away from the user interface 702. The detected movement of the user grip 724, 726 comprising tilting 728 one hand 724 which provides a user grip towards the user interface 702 and tilting 730 the other hand 726 which provides a user grip away from the user interface 702 is interpreted as a rotation of the user interface 702 of the portable electronic device 700. This interpretation has allowed the map application 712 to update the current orientation 720 of the user with respect to the displayed map 712.

The apparatus may advantageously be able to determine rotations (direction and magnitude) by determining a movement of a user's gip position away from a neutral position. Such functionality may at least partially replace reliance on, for example, a gyroscope and/or compass of an apparatus, and/or may be used as a confirmation/back-up measurement of the rotation of a device determined using other means to provide more accurate or more reliable orientation information.

FIGS. 8a and 8b illustrate the initial determination of the neutral position of a user's grip holding a portable electronic device 800. FIG. 8a shows a device 800 being held by a user by the left hand 802 and right hand 804. The user in this example has just picked up the device from a rest position in which it was not being held, for example from a table top or the user's pocket.

The device 800 comprises an apparatus configured to establish the neutral position of the grip of the user 802, 804 holding the portable electronic device 800 over a predetermined period of time, during which the user grip 802, 804 remains substantially stationary with respect to the portable electronic device 800. FIG. 8a shows the user holding the device 800, and though the user's right hand 804 is shaking 808 (that is, is not absolutely stationary with respect to the user interface of the device 800), this movement 808 is within a predetermined movement tolerance range for calibration 808. The user holds the device in a neutral grip for, in this example, five seconds, as indicated by the displayed counter 810. Of course, the calibration period may be more or less than five seconds. The device 800 is also displaying the indicator “Calibrating . . . ” 808 so the user is prompted to try and keep still and keep their grip in a neutral (comfortable and natural) position. FIG. 8b shows that the calibration is complete 812.

The apparatus may also be configured to re-establish the neutral position of the grip 802, 804 of the user holding the portable electronic device 800 after an inactivity period, the inactivity period being a period during which no grip is detected on the portable electronic device. For example, the inactivity period may be the period during which the device 800 is sat on a table, recharging in a charging cradle, or sat in the user's pocket or bag. By re-establishing the neutral position after a period of inactivity, different users with different neutral grips may use the device and benefit from the functionality provided by the apparatus. For example, a child may be expected to have a different neutral grip from an adult.

The inactivity period may be set so that, if the user merely puts the device down for a short while, this short while is less than the inactivity period and the user need not re-calibrate the neutral position each time after releasing his or her grip from the device for any amount of time. Also, the inactivity period may be set so that it may be reasonable to expect that re-calibration is required (for example, overnight). In other examples, prior to re-calibration, the device may prompt the user whether or not they wish to perform the recalibration. A new user may wish to, whereas the same user after a short break from the device may not wish to.

In the examples above, the apparatus may be configured to determine the neutral position of the grip of the user holding the portable electronic device within a predetermined tolerance range of grip positions. Thus after (and during) determination of the neutral position, changes within, for example, +/−3 degrees may be ignored for the purpose of determining a change in grip to prevent the user interface trying to perform very small user inputs very often, which may be annoying for the user. Along with this idea, after calibration, movements of the user's grip away from the neutral position may be required to exceed a predetermined movement threshold (for example, a threshold of 2 degrees), below which no user input is recognised and above which the apparatus interprets the movement as intentional and thus controlling functionality of the device accordingly.

In other examples, the neutral position of the grip of a user holding a portable electronic device may be performed during use of the portable electronic device in a mode other than a calibration mode. The determination of the neutral grip position may be re-performed during a user's interaction with a device. For example, if the apparatus determines that the user's grip has not moved for a predetermined period of time, the last grip position used during that time may be used as a new neutral position. As another example, the apparatus may be configured to perform continuous calibration, and thus periodically check and re-set the neutral position of the grip of the user holding a device, for example as the last grip position used. The neutral position therefore need not necessarily only be the grip established during a dedicated calibration mode as described in relation to FIG. 8, but may instead/additionally include neutral position determination during operation, continually and/or periodically of the device by the user.

FIG. 9 shows an example of an apparatus comprised in a device 900 which is separate to and distinct from the device on which the user input is carried out. FIG. 9 shows a remote controller 900 with a series of example controls displayed (pause 910, play 912, rewind 916 and fast forward 914). The user is holding the remote control in a neutral position with a left hand 902 and a right hand 904. The remote control 900 is configured to control the movie being displayed on a remote/non-integral television screen 906. As well as using the displayed controls 910, 912, 914, 916 to control the moving being played on the television 906, the user may, as in the previous examples, move his grip away from the neutral position in order to control the move being played on the television 906. Thus, as an example, the user may tilt his right hand away from the screen of the remote controller 900 to fast forward, or skip to the next scene, in the movie being played on the television. The remote controller 900 may have other functionality than controlling the television 906 (for example, the device 900 may be a smartphone 900 with a remote control application available). The television 906 may have other functionality which cannot be controlled by the remote control 900 (such as accessing menus). The two devices can communicate via, in this example, a wireless link 908 such as Bluetooth or over a wireless local area network (WLAN). The two devices 900, 906 have their own separate and distinct functionalities and may each be used independently of each other.

Thus it may be said that functionality provided using the portable electronic device/apparatus 900 is provided on a second device 906 separate to the portable electronic device 900 but which is controlled using the portable electronic device 900. Also, the portable electronic device 900 and the second device 906 are each independently operable.

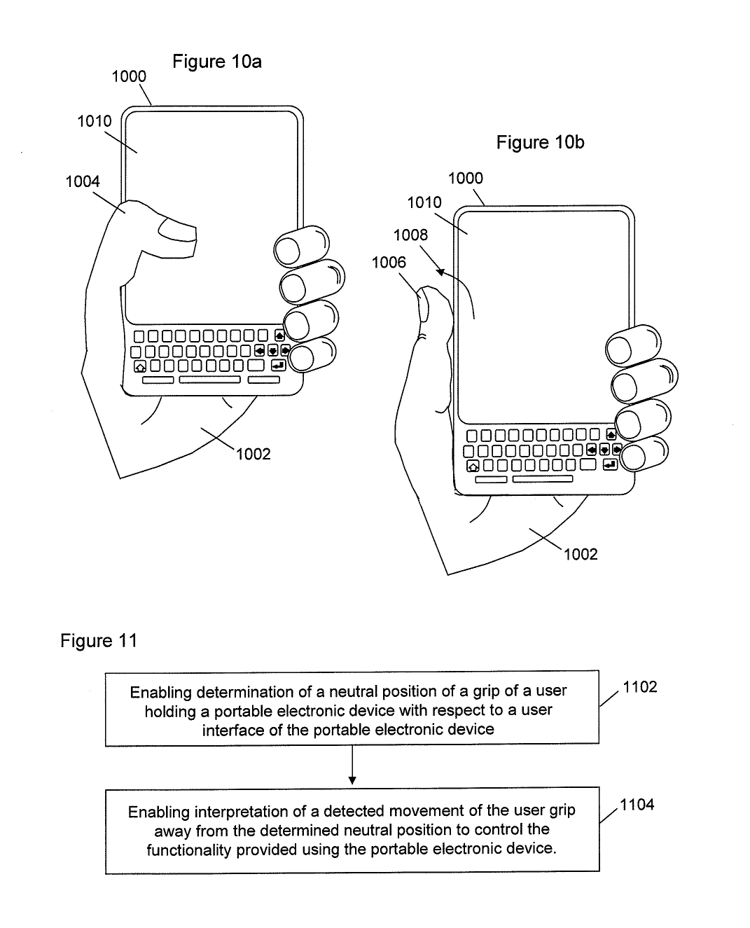

FIGS. 10a-10b illustrate an example of the apparatus/device in use. The device 1000 in this example is a mobile terminal such as a mobile telephone, smartphone, or PDA, and comprises the apparatus. It will be appreciated that the apparatus could also be considered to be the portable electronic device 1000. The device 1000 in this example is being held in a portrait orientation by one hand 1002 of a user. The device 1000 in this example has a capacitive touch sensitive input panel/user interface 1010 which overlays the display screen, so that the screen can be used as an input and output element.

The device 1000 may be running an application in which a user can scroll up/down; this may be a document reader, internet browser, address book or contacts list, or any other suitable application. The user in FIG. 10a is holding the apparatus/device 1000 in a neutral grip in his left hand 1002, with his thumb 1004 partially over the screen 1010. The apparatus 1000 is configured to enable determination of the neutral position of a grip 1002 of a user holding a portable electronic device 1000 with respect to a user interface 1010 of the portable electronic device 1000, as in earlier examples.

The user decides to scroll up through a page/list displayed on the screen 1010 of the device 1000. The capacitive touch sensitive input panel 1010 is able to sense the presence and position of a user's thumb over the screen as in FIG. 10a, and at the edges of the device 1000 and screen 1010.

FIG. 10b shows that the user has moved 1008 his left thumb 1006 away from the screen 1010, away from the neutral position of FIG. 10a, which is recognised by the apparatus 1000, via the screen 1010, as a user input which has the effect, in this example, of scrolling up through a displayed page/list. In other words, the apparatus has enabled interpretation of a detected movement 1008 of the user grip 1006 away from the determined neutral position to control the functionality provided using the portable electronic device 1000, and cause the page to be scrolled through. The user's thumb 1006 need not remain in contact with the screen 1010, nor necessarily with the device 1000 provided its position and movement can be detected by the capacitive touch sensitive input panel 1010, which may have a detected range of a few centimeters away from the screen 10101 surface.

Thus the movement away from a neutral position of a user's grip of a device is possible with a one-handed grip, and with the device 1000 held in a portrait orientation. In other examples, a device may be held by one hand in a landscape orientation. In other examples, a device may be held by two hands in a portrait orientation. In other examples, a device may be in an orientation other than portrait or landscape (that is, at an angle between the two orientations).

FIG. 11 shows a flow diagram illustrating the steps of enabling determination of a neutral position of a grip of a user holding a portable electronic device with respect to a user interface of the portable electronic device 1102 and enabling interpretation of a detected movement of the user grip away from the determined neutral position to control the functionality provided using the portable electronic device 1104.

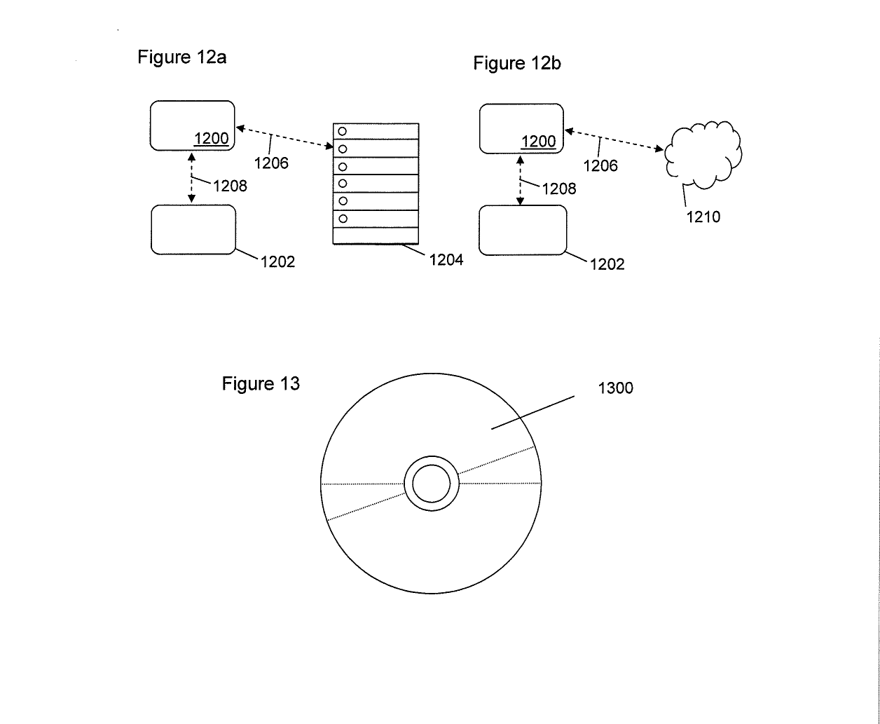

FIG. 12a illustrates an example embodiment of an apparatus according to the present disclosure in communication with a remote server. FIG. 12b shows that an example embodiment of an apparatus according to the present disclosure in communication with a “cloud” for cloud computing. In FIGS. 12a and 12b, apparatus 1200 (which may be apparatus 100, 200, 300, or a mobile terminal 400, 500, 600, 700, 800, 900 which is, or comprises, the apparatus) is in communication with 1208, or may be in communication with, another device. For example, an apparatus 1200 may be communication with another element of a portable electronic device such as a display screen, memory, processor and/or input devices such as a capacitive touch-screen input panel. As another example, an apparatus such as remote controller may be in communication with a second device, such as a television. The apparatus 1200 is also in communication with 1206 a remote computing element 1204, 1210. Such communication may be via a communications unit, for example.

FIG. 12a shows the remote computing element to be a remote server 1204, with which the apparatus may be in wired or wireless communication (e.g., via the internet, Bluetooth, a USB connection, or any other suitable connection as known to one skilled in the art). In FIG. 12b, the apparatus 1200 is in communication with a remote cloud 1210 (which may, for example, by the Internet, or a system of remote computers configured for cloud computing).

FIG. 13 illustrates schematically a computer/processor readable medium 1300 providing a program according to an example. In this example, the computer/processor readable medium is a disc such as a digital versatile disc (DVD) or a compact disc (CD). In other examples, the computer readable medium may be any medium that has been programmed in such a way as to carry out an inventive function. The computer program code may be distributed between the multiple memories of the same type, or multiple memories of a different type, such as ROM, RAM, flash, hard disk, solid state, etc.

Any mentioned apparatus/device and/or other features of particular mentioned apparatus/device may be provided by apparatus arranged such that they become configured to carry out the desired operations only when enabled, e.g., switched on, or the like. In such cases, they may not necessarily have the appropriate software loaded into the active memory in the non-enabled (e.g., switched off state) and only load the appropriate software in the enabled (e.g., on state). The apparatus may comprise hardware circuitry and/or firmware. The apparatus may comprise software loaded onto memory. Such software/computer programs may be recorded on the same memory/processor/functional units and/or on one or more memories/processors/functional units.

In some examples, a particular mentioned apparatus/device may be pre-programmed with the appropriate software to carry out desired operations, and wherein the appropriate software can be enabled for use by a user downloading a “key”, for example, to unlock/enable the software and its associated functionality. Advantages associated with such examples can include a reduced requirement to download data when further functionality is required for a device, and this can be useful in examples where a device is perceived to have sufficient capacity to store such pre-programmed software for functionality that may not be enabled by a user.

Any mentioned apparatus/circuitry/elements/processor may have other functions in addition to the mentioned functions, and that these functions may be performed by the same apparatus/circuitry/elements/processor. One or more disclosed aspects may encompass the electronic distribution of associated computer programs and computer programs (which may be source/transport encoded) recorded on an appropriate carrier (e.g., memory, signal).

Any “computer” described herein can comprise a collection of one or more individual processors/processing elements that may or may not be located on the same circuit board, or the same region/position of a circuit board or even the same device. In some examples one or more of any mentioned processors may be distributed over a plurality of devices. The same or different processor/processing elements may perform one or more functions described herein.

The term “signalling” may refer to one or more signals transmitted as a series of transmitted and/or received electrical/optical signals. The series of signals may comprise one, two, three, four or even more individual signal components or distinct signals to make up said signalling. Some or all of these individual signals may be transmitted/received by wireless or wired communication simultaneously, in sequence, and/or such that they temporally overlap one another.

With reference to any discussion of any mentioned computer and/or processor and memory (e.g., including ROM, CD-ROM etc), these may comprise a computer processor, application specific integrated circuit (ASIC), field-programmable gate array (FPGA), and/or other hardware components that have been programmed in such a way to carry out the inventive function(s).

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/examples may consist of any such individual feature or combination of features. In view of the foregoing description it will be evident to a person skilled in the art that various modifications may be made within the scope of the disclosure.

While there have been shown and described and pointed out fundamental novel features as applied to examples thereof, it will be understood that various omissions and substitutions and changes in the form and details of the devices and methods described may be made by those skilled in the art without departing from the scope of the disclosure. For example, it is expressly intended that all combinations of those elements and/or method steps which perform substantially the same function in substantially the same way to achieve the same results are within the scope of the disclosure. Moreover, it should be recognized that structures and/or elements and/or method steps shown and/or described in connection with any disclosed form or examples may be incorporated in any other disclosed or described or suggested form or example as a general matter of design choice. Furthermore means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

1. An apparatus comprising:
at least one processor; and
at least one memory including computer program code,
the at least one memory and the computer program code configured to, with the at least one processor, cause the apparatus to perform at least the following:
enable determination of a neutral position of a grip of a user holding a portable electronic device with respect to a user interface of the portable electronic device; and
enable interpretation of a detected movement of the user grip away from the determined neutral position to control the functionality provided using the portable electronic device.

2. The apparatus of claim 1, wherein the apparatus is configured to:
enable performance of a function provided using the portable electronic device corresponding to the movement of the user grip away from the determined neutral position.

3. The apparatus of claim 1, wherein the user interface of the portable electronic comprises one or more of:
a touch sensitive input panel of the portable electronic device;
a capacitive touch input panel of the portable electronic device;
an input sensor of the portable electronic device;
an input sensing array of the portable electronic device; and
an output display of the portable electronic device.

4. The apparatus of claim 1, wherein the functionality provided using the portable electronic device is associated with one or more of: a camera application, a movie application, an image viewer, a map viewer, an audio player application, a web browser, a document reader application, an e-book application, a game, a communication application, an address book application, a file manager, a menu grid, and a multi-desktop system.

5. The apparatus of claim 1, wherein the control of the functionality provided using the portable electronic device comprises one or more of:
zooming in and out of a static or moving image;
moving forward and backward through a series of images, pages, browser windows, audio/video files or entries;
controlling a game element; and
fast-forwarding and rewinding an audio or video file.

6. The apparatus of claim 1, wherein the detected movement of the user grip away from the determined neutral position to control the functionality provided using the portable electronic device comprises tilting one or both hands which provide the user grip towards or away from the user interface.

7. The apparatus of claim 1, wherein the detected movement of the user grip away from the determined neutral position to control the functionality provided using the portable electronic device comprises tilting one hand which provides a user grip towards the user interface and tilting the other hand which provides a user grip away from the user interface.

8. The apparatus of claim 7, wherein the detected movement of the user grip comprising tilting one hand which provides a user grip towards the user interface and tilting the other hand which provides a user grip away from the user interface is interpreted as a rotation of the user interface of the portable electronic device.

9. The apparatus of claim 1, wherein interpretation of the detected movement of the user grip away from the determined neutral position comprises consideration of one or more of:
the direction of detected movement of the user grip away from the determined neutral position;
the magnitude of detected movement of the user grip away from the determined neutral position;
the speed of detected movement of the user grip away from the determined neutral position;
the angular velocity of detected movement of the user grip away from the determined neutral position;
the acceleration of detected movement of the user grip away from the determined neutral position; and
the pressure applied by the user grip during the detected movement of the user grip away from the determined neutral position.

10. The apparatus of claim 1, wherein the apparatus is configured to:
establish the neutral position of the grip of the user holding the portable electronic device over a predetermined period of time, during which the user grip remains substantially stationary with respect to the portable electronic device.

11. The apparatus of claim 1, wherein the apparatus is configured to:
re-establish the neutral position of the grip of the user holding the portable electronic device after an inactivity period, the inactivity period being a period during which no grip is detected on the portable electronic device.

12. The apparatus of claim 1, wherein the apparatus is configured to determine the neutral position of the grip of the user holding the portable electronic device within a predetermined tolerance range of grip positions.

13. The apparatus of claim 1, wherein the portable electronic device comprises one or more of:
a mobile telephone; a smartphone, a personal digital assistant, a camera, a video camera, a navigator, a media player, a tablet computer, a remote controller, and a clock.

14. The apparatus of claim 1, wherein functionality provided using the portable electronic device is provided on the portable electronic device.

15. The apparatus of claim 1, wherein functionality provided using the portable electronic device is provided on a second device separate to the portable electronic device but which is controlled using the portable electronic device.

16. The apparatus of claim 15, wherein the portable electronic device and the second device are each independently operable.

17. The apparatus of claim 1, wherein the apparatus is the portable electronic device or a module for the same.

18. A computer readable medium comprising computer program code stored thereon, the computer readable medium and computer program code being configured to, when run on at least one processor, perform at least the following:
enable determination of a neutral position of a grip of a user holding a portable electronic device with respect to a user interface of the portable electronic device; and
enable interpretation of a detected movement of the user grip away from the determined neutral position to control the functionality provided using the portable electronic device.

19. A method comprising:
enabling determination of a neutral position of a grip of a user holding a portable electronic device with respect to a user interface of the portable electronic device; and
enabling interpretation of a detected movement of the user grip away from the determined neutral position to control the functionality provided using the portable electronic device.
